(19) United States
(12) Patent Application Publication
(10) Pub. No.: US 2016/0226196 A1
(43) Pub. Date: Aug. 4, 2016

(54) CONTACT SPRING WASHER AND PLUG-IN CONNECTOR

(71) Applicant: PHOENIX CONTACT GMBH & CO. KG, Blomberg (DE)

(72) Inventors: Manuel TUENKER, Doerentrup (DE); Valeri REIMCHEN, Steinheim Sandebeck (DE); Cord STARKE, Blomberg (DE)

(21) Appl. No.: 15/022,568

(22) PCT Filed: Sep. 17, 2014
(86) PCT No.: PCT/EP2014/069808

§ 371 Date: Mar. 17, 2016

(30) Foreign Application Priority Data
Sep. 20, 2013 (DE) 10 2013 015 574.6

(51) Int. Cl. H01R 13/6592

(52) U.S. Cl. CPC H01R 13/6592

(57) ABSTRACT

A contact spring washer includes a plurality of U-shaped regions arranged in an annular manner, each U-shaped region having two webs arranged substantially in parallel with one another, wherein the two webs of a first U-shaped region are interconnected by means of a first connecting web at a radially outer end of the two webs, wherein adjacent U-shaped regions are interconnected by a second connecting web at a radially inner end of the webs of said regions, and wherein the U-shaped regions each have at least one curve in the region of the two webs arranged substantially in parallel with one another.

### CROSS REFERENCE TO RELATED APPLICATIONS

This application is a U.S. National Stage Application under 35 U.S.C. §371 of International Application No. PCT/EP2014/069808 filed on Sep. 17, 2014, and claims benefit to German Patent Application No. DE 10 2013 015 574.6 filed on Sep. 20, 2013. The International Application was published in German on Mar. 26, 2015 as WO 2015/040066 A1 under PCT Article 21(2).

### FIELD

The invention relates to a contact spring washer. The invention further relates to a plug-in connector.

### BACKGROUND

Plug-in connectors that are in particular used on wind turbines need to be as fully shielded as possible in order to effectively carry away in particular excess voltages, which can occur as a result of a lightning strike, for example. To this end, it is necessary to contact the shield of the cable, for example in the form of a shielding braid, which surrounds the wires of the cable and is arranged below the sheath of the cable. This is generally only possible with a great deal of complexity. For example, it is known to strip the free end of the cable, unbraid the shielding braid below, turn it down and place it over the sheath of the cable. In order to form a contact, a metal sleeve is then passed over the folded down shielding braid and screwed or crimped to the shielding braid such that the shielding braid is clamped between the metal sleeve and the sheath of the cable. This method is often used in coaxial plug-in connectors or overmoulded plug-in connectors, such as described in EP 0 207 322 B1.

In the case of plug-in connectors that can be freely assembled, either a similar method is used or the contact is formed by means of a resilient element, such as a contact spring washer, which can be activated by means of a housing for example. The continuation of the shielding is then normally achieved by means of a screw connection, which corresponds to an appropriate screw part of a mating plug.

It is known to use a spiral spring washer as a contact spring washer, although said spiral spring washer is complex to produce, as a result of which high production costs can arise for the contact spring washer and thus also for the plug-in connector in which one or more of these contact spring washers are arranged. In addition, a spiral spring washer can have disadvantages when it is expanded and deformed.

### SUMMARY

In an embodiment, the present invention provides a contact spring washer including a plurality of U-shaped regions arranged in an annular manner, each U-shaped region having two webs arranged substantially in parallel with one another, wherein the two webs of each U-shaped region are interconnected by a first connecting web at a radially outer end of the two webs, wherein adjacent ones of the U-shaped regions are interconnected by a second connecting web at a radially inner end of the webs of the regions, and wherein each of the U-shaped regions has at least one curve in the region of the respective two webs.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic sectional view of a plug-in connector according to an embodiment of the invention,

FIG. 2 is a schematic perspective view of a contact spring washer according to a first embodiment of the invention,

FIG. 3 is a schematic plan view, viewed from the front, of the contact spring washer shown in FIG. 2,

FIG. 4 is a schematic perspective view of a contact spring washer according to a second embodiment of the invention,

FIG. 5 is a schematic plan view, viewed from the front, of the contact spring washer shown in FIG. 4,

FIG. 6 is a schematic view of an arrangement of the contact spring washer shown in FIGS. 2 and 3 on a cable,

FIG. 7 is a schematic view of a detail of an arrangement of the contact spring washer shown in FIGS. 4 and 5 in a plug-in connector shown in FIG. 1, and

FIG. 8 is a schematic perspective view of a contact spring washer according to a third embodiment of the invention.

### DETAILED DESCRIPTION

An embodiment of the invention provides a contact spring washer and a plug-in connector, by means of which the above-mentioned disadvantages can be overcome.

The contact spring washer according to an embodiment of the invention comprises a plurality of U-shaped regions which are arranged in an annular manner and each have two webs arranged substantially in parallel with one another, the webs of a U-shaped region being interconnected by means of a first connecting web at a radially outer end of the webs, U-shaped regions arranged adjacently to one another being interconnected by means of a second connecting web at a radially inner end of the webs of said regions, and the U-shaped regions having at least one curve in the region of their webs, which are arranged substantially in parallel with one another.

Compared with an otherwise normally used spiral spring washer, the contact spring washer according to an embodiment of the invention is formed of a plurality of U-shaped regions arranged in an annular manner, U-shaped regions that are arranged adjacently in each case being interconnected. The U-shaped regions are interconnected radially inwardly from the contact spring washer, the region of the contact spring washer by which the contact spring washer, when fitted, rests on the outer surface of the object on which it is fitted, for example a cable, being radially inner. Due to the U-shaped regions, which are open in a radially inward direction, and due to the radially inward connection of the U-shaped regions arranged adjacently to one another by means of second connecting webs, the contact spring washer is meander-shaped. However, the contact spring washer is not planar or flat, but rather the U-shaped regions have a curve in the region of their webs, which are arranged substantially in parallel with one another, the curve extending in an annular manner over the entire contact spring washer and thus each web of all the U-shaped regions having this curve. The curve can have a bend radius of between 30° and 120°. The curve is formed such that the first connecting webs, which are arranged radially outwardly and are part of the U-shaped regions, are curved towards the second connecting webs, which are arranged radially inwardly and interconnect the U-shaped regions. The contact spring washer is formed so as to be freely resilient at the first connecting webs and thus radially outwardly from the U-shaped regions. If the contact spring washer has just one curve in the region of the U-shaped regions, the contact spring washer is preferably also formed so as to be freely resilient in the region of the radially inner second connecting webs. The contact spring washer can be radially deformed due to its special design, but can also be radially expanded, and so the contact spring washer can exert a radial spring action. The contact spring washer, which can be axially slid onto the object to be assembled, such as a cable, can thus compensate for various diameters, for example various diameters in the case of a cable sheath or a shield. The contact spring washer is characterised further by cost-effective production compared with a spiral spring washer, since the complexity of production compared with a spiral spring washer is reduced due to the lack of winding.

It is preferably provided that the U-shaped regions in the region of their webs, which are arranged substantially in parallel with one another, have a first curve and a second curve. By forming two curves at the two webs per U-shaped region, the contact spring washer can, in addition to the radial expansion and radial deformation, also be axially expanded and axially deformed, and so the contact spring washer can also exert an axial spring action in addition to the radial spring action. If the U-shaped regions each have two curves along the length thereof and thus between the radially inner end and the radially outer end thereof, the contact spring washer can be radially inwardly fixed in the region of the second connecting webs, which in each case connect two U-shaped regions arranged adjacently to one another, and so radially inwardly the contact spring washer has no spring action.

If the U-shaped regions each have two curves, it is preferably provided that the first curve and the second curve have differently sized bend radii. Due to the differently sized bend radii, the spring action of the contact spring washer can be improved and also adapted to each individual case.

In this case it is preferably provided that the second curve is formed so as to be nearer to the radially inner second connecting web than the first curve, the bend radius of the second curve preferably being smaller than the bend radius of the first curve. Owing to the second curve being closer radially inwards, the contact spring washer can, in the region of the second connecting webs and the radial inner ends of the U-shaped regions, rest as flat as possible on the object on which it is fitted in order to achieve axial fixing. Owing to the first curve being radially further outwards, which curve preferably has a larger bend radius than the second curve, the axial and radial spring action of the contact spring washer can be achieved. The first curve can, for example, have a bend radius of between 80° and 120°, preferably of between 90° and 110°, and the second curve can, for example, have a bend radius of between 30° and 60°, preferably of between 40° and 50°, most preferably of 45°.

In order to increase the contact points of the contact spring washer when fitted, it can preferably be provided that a U-shaped region is connected to an adjacently arranged U-shaped region by means of a third connecting web to form a further contact point radially outwardly on the contact spring washer. In this embodiment, the U-shaped regions can thus also be at least in part radially outwardly interconnected, in addition to the radially inward connection, in order to be able to form a further contact point radially outwardly on the contact spring washer.

The third connecting web is preferably V-shaped. The V-shaped third connecting web is preferably formed integrally with the adjacently arranged U-shaped regions by means of its two free ends. The region of the V-shaped third connecting web that is angled between the two ends is formed radially outwardly on the contact spring washer, this angled region ending radially outwardly preferably flush with the U-shaped regions, in particular with the first connecting web of the U-shaped regions. The V-shaped connecting web is oriented and/or arranged such that the V-shaped connecting web is open radially inwards.

In order to achieve a particularly cost-effective production, the contact spring washer can be formed from a discoid metal element, it being possible to form the webs, which are arranged substantially in parallel with one another, and the first, second and third connecting webs by lasering, punching or etching the discoid metal element. The discoid metal element can be formed of a sheet metal material, in particular a spring steel, and can have the shape of a flat washer. By lasering, punching or etching, slots which interrupt the inner contour and outer contour of the discoid metal element can be easily and quickly made in the discoid metal element, it being possible to form the webs and connecting webs by means of the slots in order to form the contact spring washer. After the webs and the connecting webs have been shaped by lasering, punching or etching, the contact spring washer can be bent once or twice in the region of the webs, in order to make the curves in the contact spring washer.

A contact spring washer designed and developed as above can be arranged in a plug-in connector, it being possible to arrange one or even two or more of the correspondingly designed contact spring washers in a plug-in connector.

The plug-in connector can comprise an insulating housing, inside which a free end of a cable is inserted, a plurality of contact elements, which are connected to the wires of the cables, and a shield sleeve, the contact spring washer being arranged on the shield enclosing the wires of the cable at a first stripped region of the free end of the cable, the cable being enclosed by a sheath of the cable in the longitudinal extension of the cable in front of and behind the contact spring washer, the contact spring washer being surrounded by the shield sleeve, and the shield sleeve being fastened to the sheath of the cable in front of and behind the contact spring washer.

The plug-in connector is characterised, inter alia, in that the complexity of production is significantly reduced compared with conventional plug-in connectors and now the whole production method can be automated in various work stations, as a result of which the production, especially of large quantities, can be particularly economical.

In the production of the plug-in connector according to an embodiment of the invention, firstly cuts are made into the sheath of the cable, which is to be inserted into the plug-in connector, at two regions, an incision being performed in the first region to the extent that only the sheath is cut into, but not the shield arranged therebelow. At the second region, which is arranged at a distance from the first region, cuts are also made into the shield in addition to into the sheath. Between the first region and the second region, the sheath and the shield remain intact on the cable. At the first region, the sheath is removed to the extent that the contact spring washer, which rests on the shield of the cable in the inserted state, can be inserted into the first region. In front of and behind the inserted contact spring washer, the cable continues to be surrounded by the sheath of the cable. By cutting through the sheath and shield in the second region, the sheath and shield can be stripped from the cable here such that an end portion of the free end of the cable is formed, at which the wires of the cable are exposed. If necessary the now exposed wires can likewise be stripped and connected to contact elements, for example by crimping. Then an electrically conductive shield sleeve, which can be produced from a metal die casting for example, is guided over the free end of the cable to the extent that the contact elements and the contact spring washer are fully covered by the shield sleeve. In order to securely position the shield sleeve, the shield sleeve is fastened to the sheath of the cable directly in front of and behind the contact spring washer. The shield sleeve is fastened to the sheath of the cable such that as a result both the contact spring washer is tightly sealed and a means of strain relief is formed for the cable. An insulating housing which covers the shield sleeve and the free end of the cable apart from a small region is then pushed over the shield sleeve, the insulating housing resting on the outer circumferential surface of the shield sleeve in some regions. Every processing step during the production process, including for producing the contact spring washer, can be fully automated such that no more manual work has to be undertaken, as a result of which the complexity as well as the costs of production and the production time can be reduced.

It is preferably provided that the contact spring washer is tensioned by the shield sleeve. This is achieved in that when the shield sleeve is fastened to the sheath, preferably by means of a crimping process, the diameter of the shield sleeve is also reduced in the region of the first contact spring washer and thus pressed towards the sheath, as a result of which the shield sleeve presses against the contact spring washer and tensions it such that the contact spring washer is radially tensioned by the shield sleeve in the finished assembled plug-in connector.

It is further preferably provided that, at a free end of the shield sleeve at which the plug-in connector can be fastened to a wall by means of the shield sleeve, a second electrically conductive contact spring washer is inserted into a recess formed in the shield sleeve. In a fastened state of the plug-in connector, the second contact spring washer, designed and developed as above, rests against the wall by means of the wall, which may be a housing wall for example, the second contact spring washer acting as a shield, in the case of a wall formed of metal, such that a shield contact can be formed between the wall and the second contact spring washer. Moreover, the second contact spring washer can compensate for any clearance formed between the plug-in connector and the wall.

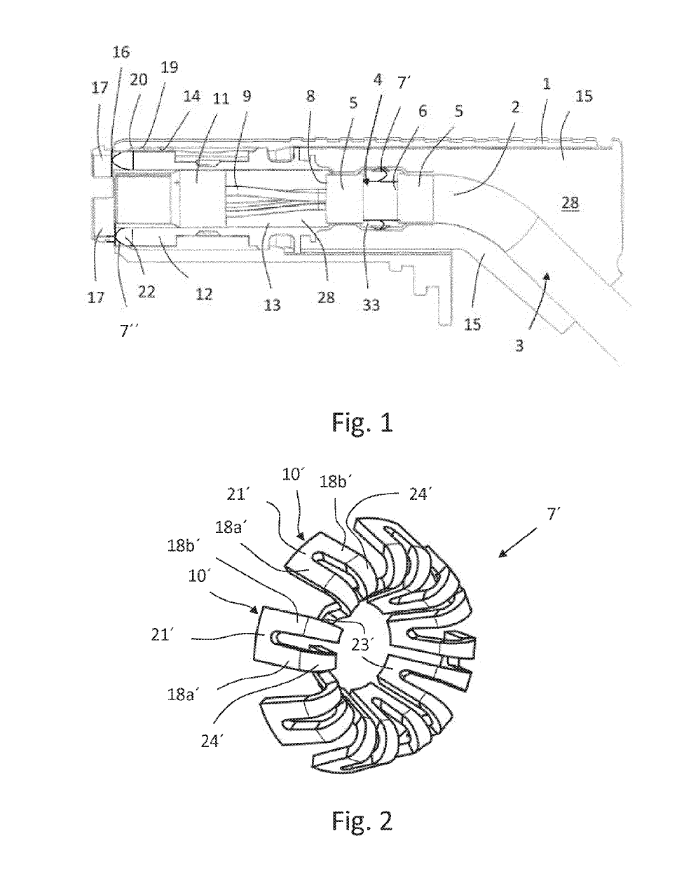

In FIG. 1, a plug-in connector according to an embodiment of the invention is shown in a sectional view. The plug-in connector has an insulating housing 1, which is substantially sleeve-shaped and forms the outer shell of the plug-in connector. Inside the insulating housing 1, a free end 2 of a cable 3 is inserted.

At the free end 2, the cable 3 has a first stripped region 4 where the sheath 5 of the cable 3 has been removed and the shield 6, which is formed as a braided shield, arranged below the sheath 5 of the cable 3 is exposed. In this first stripped region 4, a first electrically conductive contact spring washer 7′ is arranged on the shield 6. The first contact spring washer 7′ is formed in the shape of a closed ring which rests tightly on the shield 6.

At one end portion 8 of the free end 2 of the cable 3, a plurality of wires 9 of the cable 3 extend out of the cable 3 and are connected to contact elements (not visible here), the contact elements in turn being arranged in an insulating body 11. The insulating body 11 is arranged inside the plug-in connector at a distance from the end portion 8 of the free end 2 of the cable 3.

An electrically conductive shield sleeve 12, which surrounds the insulating body 11, a second space 13 formed between the insulating body 11 and the end portion 8 of the free end 2 of the cable 3, and the first contact spring washer 7′ is arranged between the insulating body 11 and the insulating housing 1. The shield sleeve 12 extends beyond the contact spring washer 7′ both in front of and behind the contact spring washer 7′ in the process and is sealingly arranged on the sheath 5 of the cable 3. In the region of the first contact spring washer 7′, the shield sleeve 12 rests on the contact spring washer 7′ and presses said washer towards the shield 6 such that the contact spring washer 7′ is radially tensioned by the shield sleeve 12.

In the region of the insulating body 11 and the second space 13, the shield sleeve 12 is thicker than in the region of the first contact spring washer 7′ such that in the region of the insulating body 11 and the second space 13, the shield sleeve 12 rests against the inner wall 14 of the insulating housing 1. An insulating material 28 is injected into a first space 15 formed between the insulating housing 1 and the free end 2 of the cable 3 arranged in the insulating housing 1, and completely fills the first space 15. In the process, the insulating material 28 adjoins an outer circumferential surface of the shield sleeve 12 in the region of the free end 2 of the cable 2 and directly adjoins the sheath 5 of the cable 3 where a shield sleeve 12 is no longer provided.

Furthermore, one or more openings (not shown here) are formed in the shield sleeve 12, by means of which openings the insulating material 28 injected into the first space 15 can also flow into the second space 13, which constitutes an interior of the shield sleeve 12 in which the exposed wires 9 of the cable 3 are inserted into the insulating body 12, such that this second space 13 forming the interior of the shield sleeve 12 preferably no longer has any regions filled with air, but rather is completely filled with the insulating material 28. The wires 9 of the cable 3 that have been inserted into the second space 13 are thus embedded in the insulating material 28.

In the first region 4, a third space 33 is formed between the shield 6, the first contact spring washer 7′ and the shield sleeve 12, yet this space is not filled by the insulating material, but rather air is arranged therein so that the first contact spring washer 7′ can be tensioned and relieved of tension.

The shield sleeve 12 is substantially completely surrounded by the insulating housing 1 apart from a region of a free end 16 of the shield sleeve 12. At the region of the free end 16, which is not covered by the insulating housing 1, the shield sleeve 12 has locking means 17 to fasten the plug-in connector to a wall. The locking means 17 are provided in the form of a plurality of locking hooks formed annularly on the end face of the shield sleeve 12.

The insulating housing 1 is mounted so as to be movable on the shield sleeve 12 and also on the insulating material 28 arranged in the first space 15 such that the insulating housing 1 can be displaced on the shield sleeve 12 and the insulating material 28, it being possible to activate the locking means 17 during a displacement movement of the insulating housing 12. A bulge 19 is formed for this purpose on the outer circumferential surface of the shield sleeve 12 near the locking means 17. An inclined stop surface 20 is provided on the interior wall 14 of the insulating housing 1. If the insulating housing 1 is pushed over the bulge 19 by means of its stop surface 20, the free end 16 of the shield sleeve 12 and thus also the locking means 17 are pressed inwards such that hooking of the locking means 17 with the wall can be triggered.

Furthermore, at the free end 16 of the shield sleeve 12, a second electrically conductive contact spring washer 7″ in the form of a closed ring is inserted into a recess 22 formed in the shield sleeve 12. The second contact spring washer 7″ is arranged near to the locking means 17 such that, when the locking means 17 hook behind the wall, the second contact spring washer 7″ exerts such a spring action on the locking means 17 that the locking means 17 are pressed outwards, and so particularly stable and secure hooking or fastening of the locking means 17 and thus of the plug-in connector to the wall is facilitated.

FIG. 2 shows a first possible embodiment of a contact spring washer 7′. The contact spring washer 7′ comprises a plurality of U-shaped regions 10′ arranged in an annular manner. The U-shaped regions 10′ each have two webs 18a′, 18b′ arranged substantially in parallel with one another, and a first connecting web 21′, which is substantially formed at a right angle to the webs 18a′, 18b′ and is integrally connected to the radially outer ends of the webs 18a′, 18b′. The individual U-shaped regions 10′ are interconnected in one piece to the U-shaped regions 10′ arranged adjacently in each case, by means of a second connecting web 23′, which is arranged radially inwardly on the contact spring washer 7′. The contact spring washer 7′ is thus in the form of a closed ring and meander-shaped.

The U-shaped regions 10′ each have a curve 24′ in the region of the webs 18a′, 18b′ of said regions, by means of which curve the webs 18a′, 18b′ are also formed to be bent in a substantially U-shaped manner from the radial inside to the radial outside over the length thereof. The first connecting web 21′ is bent towards the second connecting web 23′ by means of the curve 24′, such that the connecting webs 21′, 23′ are substantially opposite one another and oriented towards one another. The curve 24′ preferably has a bend radius of between 40° and 80°.

At the first connecting webs 21′ and thus radially outwards from the U-shaped regions 10′, the contact spring washer 7′ is formed so as to be freely resilient. The contact spring washer 7′ is furthermore also formed so as to be freely resilient radially inside on the two connecting webs 23′. The contact spring washer 7′ can be radially deformed due to its special design, but can also be radially expanded such that the contact spring washer 7′ can exert a radial spring action.

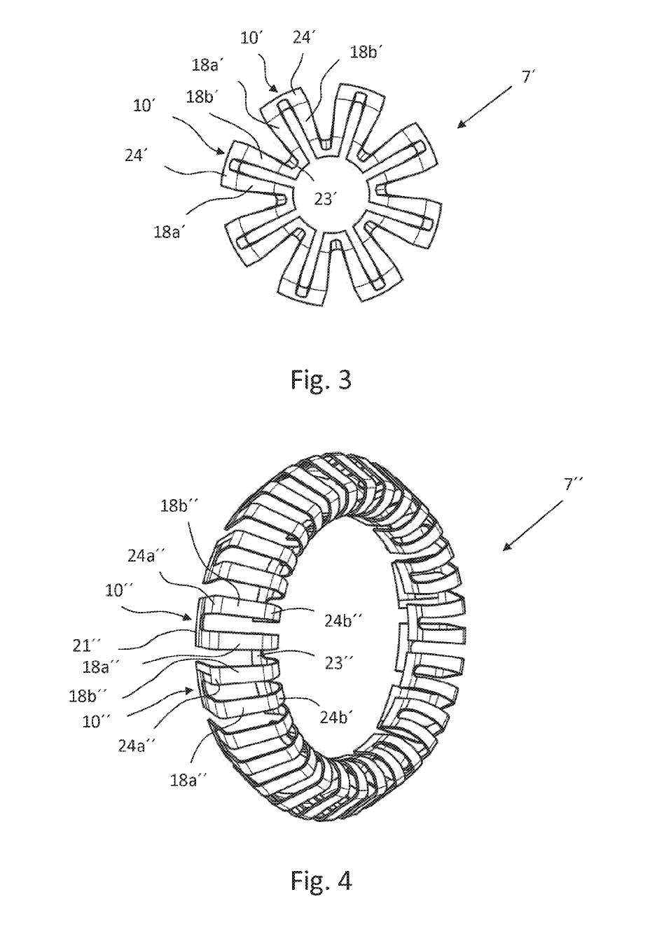

FIG. 3 is a plan view, viewed from the front, of the contact spring washer 7′ shown in FIG. 2.

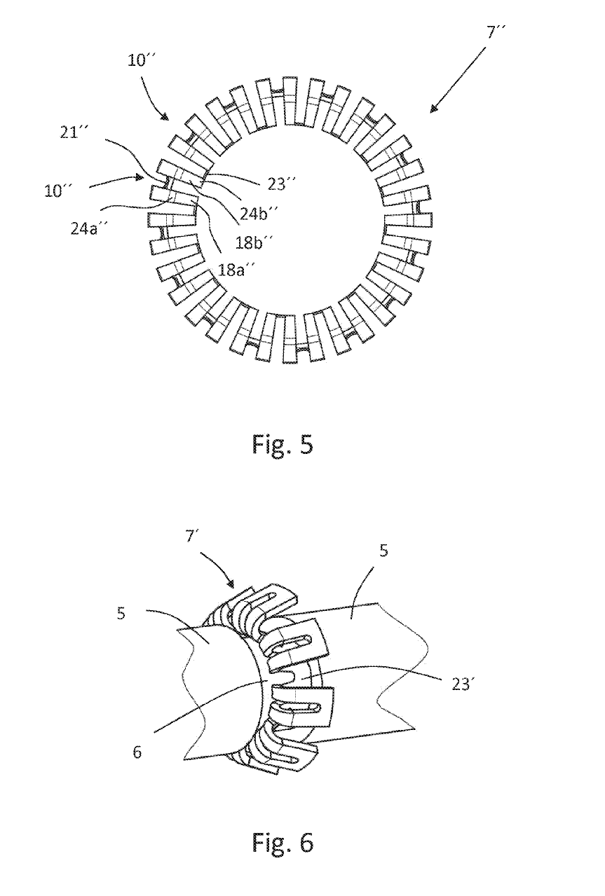

FIGS. 4 and 5 show a second possible embodiment of a contact spring washer 7″. The contact spring washer 7″ also comprises a plurality of U-shaped regions 10″ which are arranged in an annular manner and each have two webs 18a″, 18b″ arranged substantially in parallel with one another, the webs 18a″, 18b″ of a U-shaped region 10″ being interconnected radially outwardly by means of a first connecting web 21″. U-shaped regions 10″ arranged adjacently to one another are interconnected radially inwardly at their webs 18a″, 18b″ by means of a second connecting web 23″.

Unlike the contact spring washer 7′ shown in FIGS. 2 and 3, the contact spring washer 7″ shown in FIGS. 4 and 5 has two respective curves 24a″, 24b″ along the webs 18a″, 18b″ in the U-shaped regions 10″. A first curve 24a″ is formed radially further outwardly than second curve 24b″. The two curves 24a″, 24b″ have differently sized bend radii, the first curve 24a″ having a larger bend radius than the second curve 24b″. The first curve 24a″ can for example have a bend radius of between 80° and 120°, preferably of between 90° and 110° , and the second curve 24b″ can for example have a bend radius of between 30° and 60°, preferably of between 40° and 50°, more preferably of 45°. Owing to the two curves 24a″, 24b″ along the webs 18a″, 18b″ of the U-shaped regions 10″, the contact spring washer 7″ can also exert a spring action in addition to the radial spring action, such that the contact spring washer 7″ can be radially and axially expanded and deformed. Owing to the second curve 24b″ being closer radially inwards, when arranged in a plug-in connector the contact spring washer can, in the region of the second connecting webs and the radial inner ends of the U-shaped regions 10″, rest as flat as possible on the shield sleeve 12 in the recess 22 in order to achieve axial fixing. Owing to the first curve 24a″ being radially further outwards, which curve preferably has a larger bend radius than the second curve 24b″, the axial and radial spring action of the contact spring washer 7″ can be achieved.

FIG. 5 is a plan view, viewed from the front, of the contact spring washer 7″ shown in FIG. 4.

FIG. 6 is a view of a detail of the plug-in connector shown in FIG. 1 in the region where a contact spring washer 7′, designed according to the contact spring washer 7′ shown in FIGS. 2 and 3, is arranged on the shield 6 in the first stripped region 4. In the process, the contact spring washer 7′ rests radially inwardly on the shield 6 by means of the two connecting webs 23″.

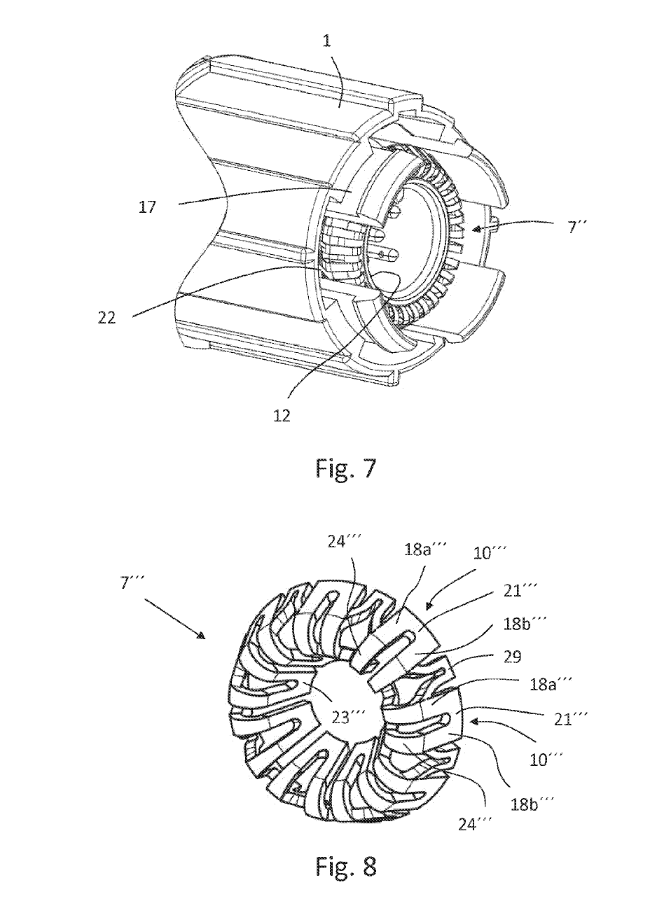

FIG. 7 is a view of a detail of the plug-in connector shown in FIG. 1 in the region where a contact spring washer 7″, which is designed according to the contact spring washer 7″ shown in FIGS. 4 and 5, is inserted in a recess 22 formed in the shield sleeve 12.

In the embodiment shown here, the contact spring washer 7′, which has just one curve 24′, is arranged on the shield 6 of the stripped cable 3 and the contact spring washer 7″, which has two curves 24a″, 24b″, is arranged in the recess 22 in the shield sleeve 12. However, the opposite is also possible, whereby the contact spring washer 7′, which only has one curve 24′, is arranged in the recess 22 in the shield sleeve 12, and the contact spring washer 7″, which has two curves 24a″, 24b″, is arranged on the shield 6 of the stripped cable 3. It is furthermore also possible that the contact spring washer 7′, which only has one curve 24′, can be arranged both on the shield 6 of the stripped cable 3 and in the recess 22 in the shield sleeve 12. Alternatively, it is also possible that the contact spring washer 7″, which has two curves 24a″, 24b″, can be arranged both on the shield 6 of the stripped cable 3 and in the recess 22 in the shield sleeve 12.

FIG. 8 shows a further possible embodiment of a contact spring washer 7″, it being possible to arrange the contact spring washer 7′ for example on the shield 6 of the stripped cable 3 or for example in the recess 22 in the shield sleeve 12.

The contact spring washer 7′ shown in FIG. 8 is similar to the contact spring washer 7′ shown in FIG. 2, a third connecting web 29 additionally being formed between two U-shaped regions 10′ of the contact spring washer 7′ in the embodiment shown in FIG. 8. The third connecting web 29 is substantially V-shaped and is integrally connected by its two free ends to two adjacently arranged U-shaped regions 10′″, in particular to the webs 18a′″, 18b′″ of the U-shaped regions 10′. The third connecting web 29 is integrally connected by its two free ends in a region of the webs 18a′″, 18b′″ between the curve 24′ and the first connecting web 21′″ of a U-shaped region 10′″. The third connecting web 29, which is arranged in a gap between two U-shaped regions 10′″, has a smaller web width than the webs 18a′″, 18b′″ and the first connecting web 21′ of the U-shaped regions 10′. The V-shaped third connecting web 29 is open radially inwards such that a closed end 30 of the third connecting web 29 is oriented radially outward. With its closed end 30, where the third connecting web 29 has a curve, the third connecting web 29 can form an additional contact point radially outwardly on the contact spring washer 7′. In the configuration shown, the closed end 30 of the third connecting web 29 ends flush with the first connecting web 21′″ of the U-shaped regions 10′″.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Insulating housing 1
Free end 2
Cable 3
First region 4
Sheath 5
Shield 6
Contact spring washer 7′, 7″, 7′
End portion 8
Wire 9
U-shaped region 10′, 10″, 10′″
Insulating body 11
Shield sleeve 12
Second space 13
Inner wall 14
First space 15
Free end 16
Locking means 17
Web 18a′, 18a″, 18a′″, 18b′, 18b″, 18b′″
Bulge 19
Stop surface 20
First connecting web 21′, 21″, 21′″
Recess 22
Second connecting web 23′, 23″, 23′″
Curve 24′, 24a″, 24b″, 24′
Insulating material 28
Third connecting web 29
Closed end 30
Third space 33

1. A contact spring washer comprising:
a plurality of U-shaped regions arranged in an annular manner, each U-shaped region having two webs arranged substantially in parallel with one another, wherein the two webs of U-shaped region are interconnected by a first connecting web at a radially outer end of the two webs,
wherein adjacent one of the U-shaped regions are interconnected by a second connecting web at a radially inner end of the webs of the regions, and
wherein each of the U-shaped regions has at least one curve in the region of the respective two webs.

2. The contact spring washer according to claim 1, wherein the at least one curve includes a first curve and a second curve in the region of the two webs.

3. The contact spring washer according to claim 2, wherein the first curve and the second curve have differently sized bend radii.

4. The contact spring washer according to claim 2, wherein the second curve is formed so as to be nearer to the radially inner second connecting web than the first curve, the bend radius of the second curve being smaller than the bend radius of the first curve.

5. The contact spring washer according to claim 1, wherein each 01 the plurality of U-shaped regions is connected to an adjacent one of the plurality of U-shaped regions by a third connecting web so as to form a further contact point radially outwardly on the contact spring washer.

6. The contact spring washer according to claim 5, wherein the third connecting web is V-shaped.

7. The contact spring washer according to claim 1, wherein the contact spring washer is formed from a discoid metal element, and wherein the webs and connecting webs are formed by one or more of lasering, punching, or etching the discoid metal clement.

8. A plug in connector comprising:
at least one contact spring washer including:
a plurality of U-shaped regions arranged in an annular manner, each U-shaped region having two webs arranged substantially in parallel with one another, wherein the two webs of a each U-shaped region are interconnected a first connecting web at a radially outer end of the two webs,
wherein adjacent U-shaped regions are interconnected by a second connecting web at a radially inner end of the webs of the regions, and
wherein each of the U-shaped regions has at least one curve in the region of the two webs.

9. The plug-in connector according to claim 8, wherein the plug-in connector comprises:
an insulating housing, inside of which a free end of a cable is inserted,
a plurality of contact elements, which are connected to the wires of the cables, and
a shield sleeve,
wherein the contact spring washer is arranged on the shield enclosing the wires of the cable at a first stripped region of the free end of the cable,
wherein the cable being is enclosed by a sheath of the cable in front of and behind the contact spring washer,
wherein the contact spring washer is surrounded by the shield sleeve, and
wherein the shield sleeve is fastened to the sheath of the cable in front of and behind the contact spring washer.

10. The plug-in connector according to claim 9, wherein the contact spring washer is tensioned by the shield sleeve.

11. The plug-in connector according to claim 9, wherein, at a free end of the shield sleeve at which the plug-in connector can be fastened to a wall by the shield sleeve, a second electrically conductive contact spring washer is inserted into a recess formed in the shield sleeve.
